(19) United States
(12) Patent Application Publication
(10) Pub. No.: US 2024/0170729 A1
(43) Pub. Date: May 23, 2024

(54) SEPARATOR FOR LITHIUM SECONDARY BATTERY, LITHIUM SECONDARY BATTERY INCLUDING THE SAME, AND METHOD FOR MANUFACTURING THE SEPARATOR FOR LITHIUM SECONDARY BATTERY

(71) Applicant: ELECTRONICS AND TELECOMMUNICATIONS RESEARCH INSTITUTE, Daejeon (KR)

(72) Inventors: Dong Ok SHIN, Daejeon (KR); Young-Gi LEE, Daejeon (KR); JINWOO LEE, Daejeon (KR); Myeong Ju LEE, Daejeon (KR); Seong Eun JO, Daejeon (KR); Jaecheol CHOI, Daejeon (KR)

(21) Appl. No.: 18/513,187

(22) Filed: Nov. 17, 2023

(30) Foreign Application Priority Data
Nov. 21, 2022 (KR) 10-2022-0156710
Mar. 29, 2023 (KR) 10-2023-0041269

(51) Int. Cl. H01M 10/0585; H01M 4/134; H01M 10/0525; H01M 10/0562; H01M 10/0569

(52) U.S. Cl. CPC H01M 10/0585; H01M 4/134; H01M 10/0525; H01M 10/0562; H01M 10/0569; H01M 2004/021

(57) ABSTRACT

Provided is a separator for a lithium secondary battery. The separator for the lithium secondary battery may include a separator substrate, a first coating layer on the separator substrate, and a second coating layer on the first coating layer, wherein the first coating layer includes a solid electrolyte, and the second coating layer includes a lithium compound.

### CROSS-REFERENCE TO RELATED APPLICATIONS

This U.S. non-provisional patent application claims priority under 35 U.S.C. § 119 of Korean Patent Application Nos. 10-2022-0156710, filed on Nov. 21, 2022, and 10-2023-0041269, filed on Mar. 29, 2023, the entire contents of which are hereby incorporated by reference.

### BACKGROUND

The present disclosure herein relates to a separator for a lithium secondary battery and a manufacturing method thereof.

Lithium secondary batteries are utilized as power sources of small electronic devices such as mobile phones and laptops due to excellent energy density, high life characteristics, and high driving voltage, and recently, the scope of utilization thereof has been expanded to an energy storage system (ESS) for storing power obtained from electric vehicles or renewable energy. Accordingly, an electrode for a lithium secondary battery having a high energy density is being developed, and since graphite, which is a negative electrode material conventionally used, has a low theoretical capacity, the utilization of a lithium metal negative electrode having a capacity higher than that of graphite is continuously required. In addition, next-generation lithium secondary battery systems utilizing a lithium metal as an electrode, such as lithium-sulfur, lithium-air, and all-solid-state batteries, are also being studied.

The lithium secondary battery basically includes a positive electrode, a negative electrode, an electrolyte, and a separator, and in order to be electrically neutral, lithium ions move through the electrolyte in the battery between the positive electrode and the negative electrode, when the battery is driven, in response to electrons moving along an external wire. In this case, a polymer separator is disposed between the positive electrode and the negative electrode, and the flow of electrons is blocked while maintaining the flow of lithium ions in the electrolyte through the pores of the polymer separator, thereby preventing an internal short circuit. The polymer separator is manufactured by pulling and orienting polyolefin in a heated state, and is classified into a wet type and a dry type according to the presence or absence of a solvent extraction process. The polymer separator has a pore distribution ranging from tens of nanometers to tens of micrometers, and lithium ions move in the electrolyte through the pores. The polyolefin polymer separator currently used has weak heat resistance properties and mechanical strength, and thus acts as a factor that threatens the safety of lithium secondary batteries. Therefore, in order to solve such a limitation and improve the life and performance of a lithium secondary battery, studies on a separator are being carried out.

### SUMMARY

The present disclosure provides a separator for a lithium secondary battery, the separator having improved safety, life characteristics, and performance.

The present disclosure also provides a lithium secondary battery having improved safety, life characteristics, and performance.

The present disclosure also provides a method for manufacturing the separator for a lithium secondary battery, the separator having improved safety, life characteristics, and performance.

The purpose of the present disclosure is not limited to the aforementioned, but other purposes not described herein will be clearly understood by those skilled in the art from descriptions below.

An embodiment of the inventive concept provides a separator for a lithium secondary battery including a separator substrate, a first coating layer on the separator substrate, and a second coating layer on the first coating layer, wherein the first coating layer includes a solid electrolyte, and the second coating layer includes a lithium compound.

In an embodiment, the first coating layer may include at least one of an oxide-based solid electrolyte, a phosphate-based solid electrolyte, or a sulfide-based solid electrolyte, or a combination thereof.

In an embodiment, the second coating layer may include at least one of lithium fluoride, lithium nitride, lithium phosphate, or lithium phosphorous sulfide, or a combination thereof.

In an embodiment, the first coating layer may have a thickness of about 1 μm to about 15 μm.

In an embodiment, the first coating layer may have a porosity of about 15% to about 60%.

In an embodiment, the second coating layer may have an ion conductivity of about 10⁻⁹ S/cm to about 10⁻⁵ S/cm.

In an embodiment, the second coating layer may have an electron conductivity of about 10⁻¹⁴ S/cm to about 10⁻⁹ S/cm.

In an embodiment, the second coating layer may have a thickness of about 5 nm to about 50 nm.

In an embodiment, the first coating layer may have more uniform porous distribution than the separator substrate.

In an embodiment, the separator substrate may include polyolefin.

In an embodiment of the inventive concept, a lithium secondary battery includes a positive electrode, a negative electrode facing the positive electrode, a separator between the positive electrode and the negative electrode, and a liquid electrolyte in contact with the positive electrode, the negative electrode, and the separator, wherein the second coating layer is configured to suppress the infiltration of materials constituting the negative electrode into the first coating layer. In an embodiment, the separator may include a separator substrate, a first coating layer on the separator substrate, and a second coating layer on the first coating layer, and the first coating layer may have more uniform pore distribution than the separator substrate.

In an embodiment, the first coating layer may include at least one of an oxide-based solid electrolyte, a phosphate-based solid electrolyte, or a sulfide-based solid electrolyte, or a combination thereof.

In an embodiment, the second coating layer may include at least one of lithium fluoride, lithium nitride, lithium phosphate, or lithium phosphorous sulfide, or a combination thereof.

In an embodiment, the first coating layer may include a spherical solid electrolyte, a linear solid electrolyte, and a planar solid electrolyte.

In an embodiment, the spherical solid electrolyte may have a diameter of about 50 nm to about 3 μm.

In an embodiment, the linear solid electrolyte may have a diameter of about 50 nm to about 1 μm, and the length relative to the diameter may be about 20 to 1,000.

In an embodiment, the planar solid electrolyte may have an area of about 0.01 μm² to about 10 μm², and a thickness of about 50 nm to about 1 μm.

In an embodiment, the negative electrode may include a lithium metal.

In an embodiment of the inventive concept, a method for manufacturing the separator for a lithium secondary battery includes mixing a solid electrolyte, a binder, and a solvent to prepare a slurry, applying the slurry on a separator substrate to form a first coating layer, and forming a second coating layer including a lithium compound on the first coating layer, wherein the first coating layer may have more uniform pore distribution than the separator substrate.

In an embodiment, the second coating layer may include at least one of lithium fluoride, lithium nitride, lithium phosphate, or lithium phosphorous sulfide, or a combination thereof.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of a lithium secondary battery according to embodiments of the inventive concept;

FIG. 2 is a cross-sectional view of a separator for a lithium secondary battery according to embodiments of the inventive concept;

FIG. 3A is a scanning electron microscope (SEM) image of a separator substrate;

FIG. 3B is a SEM image of Example 1;

FIG. 4 shows SEM and EDS mapping images of Example 1;

FIG. 5 shows X-ray diffraction (XRD) graphs of Example 1;

FIGS. 6A and 6B show X-ray photoelectron spectroscopy (XPS) graphs of a first coating layer and a second coating layer;

FIG. 7 shows images of the separator substrate and Example 1;

FIG. 8 shows a graph obtained by measuring discharge capacities of Comparative Example 2 and Example 2; and

FIG. 9 shows a graph obtained by measuring discharge capacities of Comparative Example 2 and Example 2.

### DETAILED DESCRIPTION

Exemplary embodiments of the inventive concept will be described with reference to the accompanying drawings so as to sufficiently understand constitutions and effects of the present disclosure. The inventive concept may, however, be embodied in different forms and should not be construed as limited to the embodiments set forth herein. Rather, these embodiments are provided so that this disclosure will be thorough and complete, and will fully convey the scope of the present disclosure to those skilled in the art. A person with ordinary skill in the art to which the present disclosure pertains will understand that the inventive concept can be carried out under any appropriate condition.

In this specification, the terms are used only for explaining embodiments while not limiting the present disclosure. In the specification, the terms of a singular form may include plural forms unless referred to the contrary. It will be understood that the terms “comprises” and/or “comprising,” when used in this specification, specify the presence of stated components, steps, operations, and/or elements, but do not preclude the presence or addition of one or more other components, steps, operations, and/or elements.

It will be understood that when a film (or layer) is referred to as being ‘on’ another film (or layer) or substrate, it can be directly on the another film (or layer) or substrate, or intervening films (or layers) may also be present therebetween.

It will be understood that, although the terms first, second, third, etc. may be used herein to describe various regions, films (or layers), or the like, these regions and films should not be limited by these terms. These terms are used only to distinguish a predetermined region or film (or layer) from another region or film (or layer). Therefore, a layer referred to as a first layer in one embodiment can be referred to as a second layer in another embodiment. An embodiment described and exemplified herein includes a complementary embodiment thereof. Like reference numerals in the drawings denote like elements throughout.

As used herein, each of the phrases, such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof.

In addition, embodiments described herein will be described with reference to cross-sectional views and/or plan views that are ideal example views of the inventive concept. In the drawings, the thicknesses of layers and regions may be exaggerated for effective explanation of technical contents. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concept.

Unless otherwise defined, all terms used herein have the same meaning as commonly understood by one of ordinary skill in the art to which this inventive concept belongs.

Hereinafter, a separator for a lithium secondary battery, a lithium secondary battery including the same, and a method for manufacturing the separator for a lithium secondary battery according to the inventive concept will be described with reference to drawings.

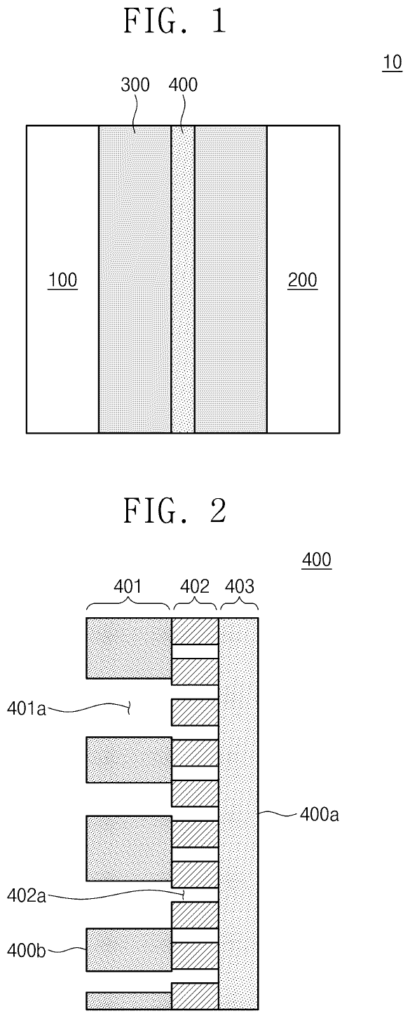

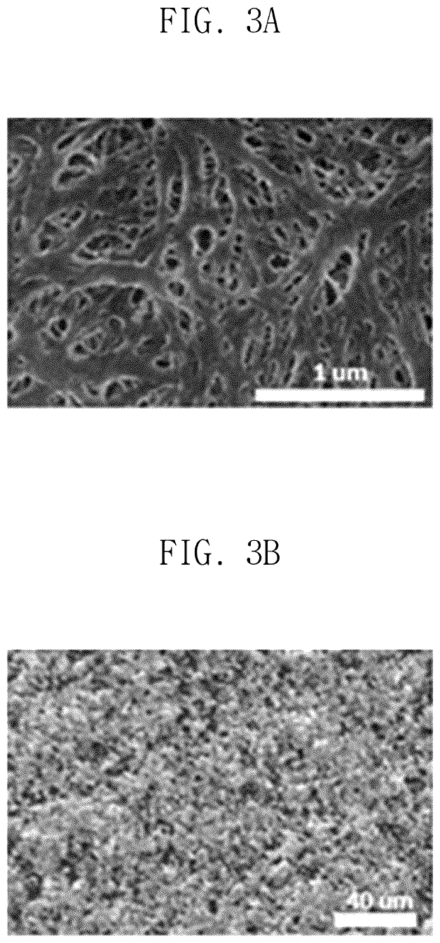

FIG. 1 is a cross-sectional view of a lithium secondary battery according to embodiments of the inventive concept. FIG. 2 is a cross-sectional view of a separator for a lithium secondary battery according to embodiments of the inventive concept.

Referring to FIGS. 1 and 2, a lithium secondary battery 10 may include a positive electrode 100, a negative electrode 200, a liquid electrolyte 300, and a separator 400.

The positive electrode 100 and the negative electrode 200 may be spaced apart from each other with the separator 400 interposed therebetween. The separator 400 may be disposed between the positive electrode 100 and the negative electrode 200. The liquid electrolyte 300 may be in contact with the positive electrode 100, the negative electrode 200, and the separator 400. The liquid electrolyte 300 may be a medium that transfers lithium ions between the positive electrode 100 and the negative electrode 200. In the liquid electrolyte 300, the lithium ions may pass through the separator 400 and move toward the positive electrode 100 or the negative electrode 200.

The positive electrode 100 may include a first current collector and a positive electrode active material layer on the first current collector. The first current collector may include a metal selected from the group consisting of aluminum, copper, nickel-plated copper, stainless steel, nickel, titanium, palladium, and an aluminum-cadmium alloy. The first current collector may have the form such as a film, a sheet, a foil, a mesh, a net, a porous body, a foam body, or a non-woven fabric body. The positive electrode active material layer may include a positive electrode active material, a binder, and a conductive material. The ratio of the positive electrode active material, the binder, and the conductive material may be about 80:10:10 to about 98:1:1. The positive electrode active material may include at least one of sulfur, lithium cobalt oxide (LiCoO₂), lithium nickel oxide (LiNiO₂), lithium nickel cobalt aluminum oxide (LiNiCoAlO₂), an olivien crystal structure of LiFePO₄, or lithium cobalt aluminum oxide (LiNiₓCo_{y}Mn_{z}O₂, where x+y+z=1), or a combination thereof. The conductive material may include, for example, at least one of graphite, hard/soft carbon, carbon fiber, carbon nanotube, linear carbon, carbon black, acetylene black, or Ketjen black, or a combination thereof. The binder may include at least one of polyvinylidene fluoride, polyimide, polytetrafluoroethylene, poly(ethylene oxide), polyacrylonitrile, hydroxypropyl cellulose, carboxymethyl cellulose, sodium carboxymethyl cellulose, styrene-butadiene rubber, or nitrile-butadiene rubber, or a combination thereof. The binder may maintain adhesion between the first current collector and the positive electrode active material layer.

The negative electrode 200 may include a second current collector and a negative electrode active material layer on the second current collector. The second current collector may be the same as the first current collector of the positive electrode 100 as described above. The negative electrode active material layer may include at least one of silicon (Si), tin (Sn), graphite, or lithium (Li), or a combination thereof. For example, the negative active material layer may be a lithium metal.

The liquid electrolyte 300 may be a liquid electrolyte. The liquid electrolyte 300 may include a salt having a structure such as A⁺B⁻ and an organic solvent. The A⁺ may include at least one alkali metal cation selected from the group consisting of Li⁺, Na⁺, and K⁺. The B⁻ may include at least one anion selected from the group consisting of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN—, and (CF₃CF₂SO₂)₂N⁻. For example, the liquid electrolyte 300 may include, for example, at least one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈, or a combination thereof. The concentration of the lithium salt in the liquid electrolyte 300 may be about 1 M to 5 M. The organic solvent may include cyclic carbonate, linear carbonate, or a combination thereof. For example, the cyclic carbonate may include at least one of butylene carbonate, ethylene carbonate, propylene carbonate, glycerin carbonate, vinylene carbonate, or fluoroethylene carbonate, or a combination thereof. The linear carbonate may include at least one of dimethyl carbonate, diethyl carbonate, ethyl methyl carbonate, dimethoxyethane, or dimethyl ethylene carbonate, or a combination thereof. The liquid electrolyte 300 may further include an additive. The additive may include at least one of fluoroethylene carbonate, biphenyl, cyclohexylbenzene, vinylene carbonate, or a combination thereof. The additive may be added in a concentration of 5 wt % or less with respect to the liquid electrolyte 300. The additive may improve the performance of the lithium secondary battery 10.

The separator 400 may be interposed between the positive electrode 100 and the negative electrode 200. The separator 400 may be disposed in the liquid electrolyte 300. The separator 400 may include a first surface 400a and a second surface 400b facing each other. The first surface 400a of the separator 400 may be one surface of a second coating layer 403 which will be described below. The separator 400 may be disposed in the lithium secondary battery 10 such that the first surface 400a faces the negative electrode 200.

The separator 400 may include a separator substrate 401, a first coating layer 402, and a second coating layer 403.

The separator substrate 401 may include a porous polymer film. For example, the separator substrate 401 may include a polyolefin separator. The separator substrate 401 may include a plurality of separator pores 401a. The separator pores 401a may have non-uniform diameter distributions. That is, the separation membrane pores 401a may include pores having different diameters. The separator pores 401a may have a diameter of about 10 nm to about 100 μm.

The first coating layer 402 may be provided on at least one surface of the separator substrate 401. The first coating layer 402 may have ion conductivity. The first coating layer 402 may have ion conductivity similar to that of the liquid electrolyte 300. The first coating layer 402 may include ceramic. The first coating 402 may include a solid electrolyte. For example, the first coating layer 402 may include at least one of an oxide-based solid electrolyte, a phosphate-based solid electrolyte, or a sulfide-based solid electrolyte, or a combination thereof. The oxide-based solid electrolyte may include Li_{7-3x+y-z}AₓLa_{3-y}B_{y}Zr_{2-z}C_{z}O₁₂ (where A is Al or Ga, B is Ca, Sr, or Ba, and C is Ta, Nb, Sb, or Bi) having a garnet-type structure and Li₃ₓLa_{(2/3)-x}_{^{□}}_{(1/3)-2x}TiO₃ (where x is 0 to 0.16, and □ is vacancy) having a perovskite structure. For example, the first coating layer 402 may include doping a Li site of Li₇₋ₓAₓLa₃Zr₂O₁₂ with Al and Ga at a ratio of about 0 mol to about 0.3 mol, doping a La site with Ca, Sr, and Ba at a ratio of about 0 mol to about 0.3 mol, or doping a Zr site with Nb, Ta, Sb, and Bi at a ratio of about 0 mol to about 0.3 mol. The phosphate-based solid electrolyte may include Li₁₊ₓAlₓTi₂₋ₓ(PO₄)₃ (where x is 0 to 0.4) having a structure of Na Super Ionic Conductor (NASICON). The sulfide-based solid electrolyte may include a compound of chalcogenide and lithium. The sulfide-based solid electrolyte may include Li_{10±1}MP₂X₁₂ (where M is Ge, Si, Sn, Al, or P, and X is S or Se), for example, Li₁₀SnP₂S₁₂ and Li₄₋ₓSn₁₋ₓAsₓS₄ (where x is 0 to 100). The sulfide-based solid electrolyte may include a solid electrolyte having a thio-lithium superionic conductor (thio-LISICON) structure, and may include, for example, Li_{3.25}Ge_{0.25}P_{0.75}S₄ and Li₁₀GeP₂S₁₂. The sulfide-based solid electrolyte may include Li₆PS₅X (where X is Cl, Br, or I) having a Li-argyrodite structure, and may include, for example, Li₆PS₅Cl. The sulfide-based solid electrolyte may include xLi₂S(100−x)P₂S₅ (where x is 0 to 100) in a glass-ceramic form, for example, Li₂SP₂S₅. The sulfide-based solid electrolyte may include Li₂P₂S₅, Li₂SSiS₂Li₃N, Li₂SP₂S₅LiI, Li₂SSiS₂LiₓMO_{y}, Li₂SGeS₂, and Li₂SB₂S₃LiI in a glass form.

The first coating layer 402 may include a zero-dimensional spherical solid electrolyte, a one-dimensional linear solid electrolyte, and a two-dimensional planar solid electrolyte. The spherical solid electrolyte may have a diameter of about 50 nm to about 3 μm. The linear solid electrolyte may have a diameter of about 50 nm to about 1 μm, and a length to the diameter, that is, an aspect ratio may be about 20 to about 1,000. The planar solid electrolyte may have an area of about 0.01 μm² to about 10 μm², and a thickness of about 50 nm to about 1 μm.

The first coating layer 402 may have a thickness of about 1 μm to about 15 μm. More specifically, the first coating layer 402 may have a thickness of about 3 μm to about 6 μm. If the thickness of the first coating layer 402 is greater than about 15 μm, the energy density per volume and per weight of the lithium secondary battery 10 may decrease.

The first coating layer 402 may include a plurality of coating layer pores 402a. The coating layer pores 402a may have a uniform diameter distribution. The diameter distribution of the coating layer pores 402a may be more uniform than the diameter distribution of the separator pores 401a. That is, the diameter sizes of the coating layer pores 402a may be similar to each other, and the diameter sizes of the separator pores 401a may be different from each other. Accordingly, lithium ions passing through the first coating layer 402 may be uniformly dispersed by the coating layer pores 402a. In addition, the first coating layer 402 may suppress the negative ions in the liquid electrolyte 300 from passing through the separator 400, thereby improving the transport rate of the lithium cations. The porosity of the first coating layer 402 may be about 15% to about 60%. When the porosity of the first coating layer 402 is greater than about 60%, the uniform dispersion and the transport rate of lithium ions in the lithium secondary battery 10 may deteriorate.

The separator 400 including the first coating layer 402 according to an embodiment of the present invention allows lithium ions to move uniformly, thereby allowing lithium metals to be electrodeposited on the negative electrode 200 in the form of a uniform film. Accordingly, the lithium secondary battery 10 may be stably driven, and life characteristics of the lithium secondary battery 10 may be improved.

On the other hand, when the separator of the lithium secondary battery is formed only with the separator substrate, the lithium ions passing through the separator substrate are non-uniformly moved toward the negative electrode due to the non-uniform diameter distribution of the pores of the separator substrate. This leads to the formation of lithium dendrites and the formation of dead lithium, and causes internal short circuit and lithium loss in the lithium secondary battery. Therefore, the capacity of the lithium secondary battery is reduced.

The second coating layer 403 may be provided on the first coating layer 402. The first coating layer 402 may be interposed between the second coating layer 403 and the separator substrate 401. The second coating layer 403 may include a lithium compound. The second coating layer 403 may include, for example, at least one of lithium fluoride (LiF), lithium nitride (Li₃N), lithium phosphate (LiPO₄), lithium sulfide (Li₂S), or lithium phosphorous sulfide (Li₃PS₄), or a combination thereof. The second coating layer 403 may have an ion conductivity of about 10⁻⁹ S/cm to about 10⁻⁵ S/cm for the conduction of lithium ions moved from the first coating layer 402. The second coating layer 403 may have an electron conductivity of about 10⁻¹⁴ S/cm to about 10⁻⁹ S/cm in order to suppress the precipitation of lithium from the negative electrode 200 to the first coating layer 402. The second coating layer 403 may have a thickness of about 5 nm to about 50 nm. The second coating layer 403 may serve to suppress side reactions between the first coating layer 402 and the lithium metals and the infiltration of the lithium metals into the first coating layer 402.

A method for manufacturing the separator for a lithium secondary battery may include mixing a solid electrolyte, a binder, and a solvent to prepare a slurry, applying the slurry on a separator substrate to form a first coating layer, and forming a second coating layer including a lithium compound on the first coating layer.

The mixing of the solid electrolyte, the binder, and the solvent to prepare a slurry may include mixing the solid electrolyte, the binder, and the solvent under a condition of about 1,000 rpm to about 2,000 rpm by using a planetary mixer. If necessary, a solvent may be further added to prepare the slurry at a viscosity suitable for the application process which will be described below. The material constituting the solid electrolyte may be the same as the material constituting the first coating layer 402 (see FIG. 2) as described above. The weight ratio of the solid electrolyte to the binder may be about 65:35 to about 99.9:0.1. More specifically, the weight ratio of the solid electrolyte to the binder may be about 85:15 to about 99:1. The binder may include at least one of polytetrafluoroethylene, polyvinylidene fluoride, polyvinylidene fluoride-hexafluoropropylene, poly(ethylene oxide), polyacrylonitrile, polyacrylic acid, styrene-butadiene, a nitrile-butadiene rubber, a butadiene rubber, a styrene butadiene rubber, polyvinyl pyrrolidone (PVP), polyacrylamides, poly N-(2-hydroxypropyl)methacrylamide (HPMA), polyethyleneimine (PEI), polyacrylic acid (PAA), divinyl ether-maleic anhydride, polyoxazoline, polyphosphates, polyphosphazenes, xanthan gum, pectins, dextran, carrageenan, guar gum, sodium carboxymethyl cellulose, lithium carboxymethyl cellulose, or sodium alginate, or a combination thereof.

The forming of the first coating layer may include applying the slurry on the separator substrate by using a gravure coater method, a small diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, and a spray coating method. The forming of the first coating layer may further include applying the slurry on the separator substrate and then performing a drying process. The drying process is a process for removing the solvent in the slurry, and may include methods of hot air drying, vacuum oven drying, or vacuum oven drying after hot air drying.

The forming of the second coating layer including the lithium compound on the first coating layer may include forming the second coating layer on the first coating layer through a physical, chemical, or electrochemical thin film manufacturing process. The thin film manufacturing method may include atomic layer deposition, chemical vapor deposition, physical vapor deposition, electroplating, electrophoresis, and chemical reaction. The material constituting the lithium compound may be the same as the material constituting the second coating layer 403 (see FIG. 2) as described above.

Hereinafter, a separator for a lithium secondary battery and a method for manufacturing a lithium secondary battery including the same according to Examples and Comparative Examples of the inventive concept will be described.

### Example 1

Lithium carbonate (Li₂CO₃), lanthanum(III) oxide (La₂O₃), and zirconium(IV) oxide (ZrO₂) were used as a precursor, aluminum oxide (Al₂O₃) and tantalum(V) oxide (Ta₂O₅) were used as a dopant, and isopropyl alcohol (IPA) was used as a solvent, and mixed for about 6 hours to about 12 hours by using a planetary mill to prepare a precursor solution. The precursor solution was subjected to a primary calcination process at about 1,000° C. for about 2 hours to about 6 hours, and then subjected to a secondary calcination process at 1,200° C. for about 2 hours to about 10 hours to prepare a preliminary solid electrolyte in the form of powder. The preliminary solid electrolyte was dissolved in IPA, and then pulverized and dried by using a planetary micro mill to prepare a solid electrolyte having a size of about 500 nm to about 3 μm. The solid electrolyte, sodium carboxymethylcellulose, and a styrene-butadiene rubber were mixed at a weight ratio of about 95:3:2, and then added to a mixed solution of water and ethanol, and mixed with zirconia balls in a planetary mixer for 30 minutes at 2,000 rpm to prepare a slurry. The polyethylene separator was subjected to surface treatment by using a UV ozone cleaner for about 20-30 minutes to change the surface properties of the polyethylene separator from hydrophobic to hydrophilic. The slurry was applied on the hydrophilic polyethylene separator by using a doctor blade to form a first coating layer having a thickness of about 6 μm. In order to form the first coating layer, the slurry was dried in a vacuum oven at about 60° C. for about 24 hours to remove the solvent. After impregnating a coating separator in a solution in which polyvinylidene fluoride was dissolved in dimethylformamide at a concentration of about 0.1 g/mL, the coating separator was placed on the first coating layer for about 10 minutes to induce a reaction as shown in Chemical Equation 1 below, and then removed. As the coating separator, a polyethylene separator or a glass fiber may be used.

—[CH₂—CF₂]₂-+2Li→2LiF+H₂+-[CH═CF═CH═CF]— [Chemical Equation 1]

According to the reaction as in Chemical Equation 1, the polyvinylidene fluoride may have a double bond formed in a backbone chain through dehydrogenation reaction, and lithium in the first coating layer may react with fluorine to form a lithium fluoride, which is a second coating layer. Accordingly, a separator for a lithium secondary battery may be manufactured.

### Example 2

Ni_{0.6}Co_{0.2}Mn_{0.2}O₂ was used as a positive electrode, a lithium metal was used as a negative electrode, ethylene carbonate and dimethyl carbonate having a volume ratio of about 1:1 to which 1 M of LiPF₆ was added, were used as a liquid electrolyte, and Example 1 was used as a separator to manufacture a lithium secondary battery.

### Comparative Example 1

A lithium secondary battery was manufactured in the same manner as in Example 2, except that a separator substrate without a coating layer was used as a separator. A polyolefin separator was used as the separator substrate.

Table 1 shows the results of measuring the thickness, electrolyte uptake rate, ion conductivity, conductance, and cation transport number of each of Example 1 and the separator substrate.

The electrolyte uptake rate was calculated according to Calculation Equation 1 below after impregnating each of Example 1 and the separator substrate in a liquid electrolyte for about 1 hour:

$$Electrolyte uptake rate ( \% ) = \qquad [ Calculation Equation 1 ]$$

$$\frac{\begin{matrix}separator weight after impregnation - \\ separator weight before impregnation\end{matrix}}{separator weight before impregnation}$$

For the measurement of ion conductivity, a cell was formed by disposing a separator between stainless steel (SUS) electrodes, and then impedance was analyzed. An ether-based electrolyte in which 1.0 M lithium bis(tirfluoromethanesulfonimide) (LiTFSI) and 2 wt % of LiNO₃ were dissolved in 1,3-dioxolane (DOL)/1,2-dimethoxyethane (DME) was used as a liquid electrolyte. An AC impedance (10 mV) was applied in a range of about 10⁻¹ Hz to about 10⁵ Hz by using a frequency response analyzer and the measurement was performed, and resistance was measured from the impedance curve and calculated according to Calculation Equation 2 below:

$$Ion conductivity = \frac{\begin{matrix}distance between \\ electrodes\end{matrix}}{resistance \times area} \qquad [ Calculation Equation 2 ]$$

The separator was disposed between the lithium electrodes and DC potentiostatic measurement and impedance measurement were performed, and then the cation transference number was calculated according to Calculation Equation 3 below:

$$Cation transference number ( {t}_{Li +} ) = \frac{{I}_{ss} ( ΔV - {I}_{0} {R}_{0} )}{{I}_{0} ( ΔV - {I}_{ss} {R}_{ss} )} \qquad [ Calculation Equation 3 ]$$

wherein I₀ above is an initial current, Iₛₛ above is an equilibrium current, R₀ above is an initial resistance, Rₛₛ above is the equilibrium resistance, and ΔV is a voltage applied to the cell.

TABLE 1

| | | | Ion | | Cation |
|---|---|---|---|---|---|
| | Thick- | Electrolyte | conduc- | Conduc- | transference |
| | ness | uptake rate | tivity | tance | number |
| | (μm) | (%) | (mS/cm) | (S) | (t_{Li+}) |
| Separator | 20 | 71.67 | 0.21 | 0.21 | 0.61 |
| substrate | | | | | |
| Example 1 | 26 | 120.14 | 0.4 | 0.31 | 0.84 |

FIG. 3A is a SEM image of a separator substrate. FIG. 3B is a SEM image of Example 1.

Referring to FIGS. 3A and 3B, it may be confirmed that the pores of the separator substrate show a non-uniform distribution, whereas the pores of Example 1 show a more uniform distribution than the separator substrate.

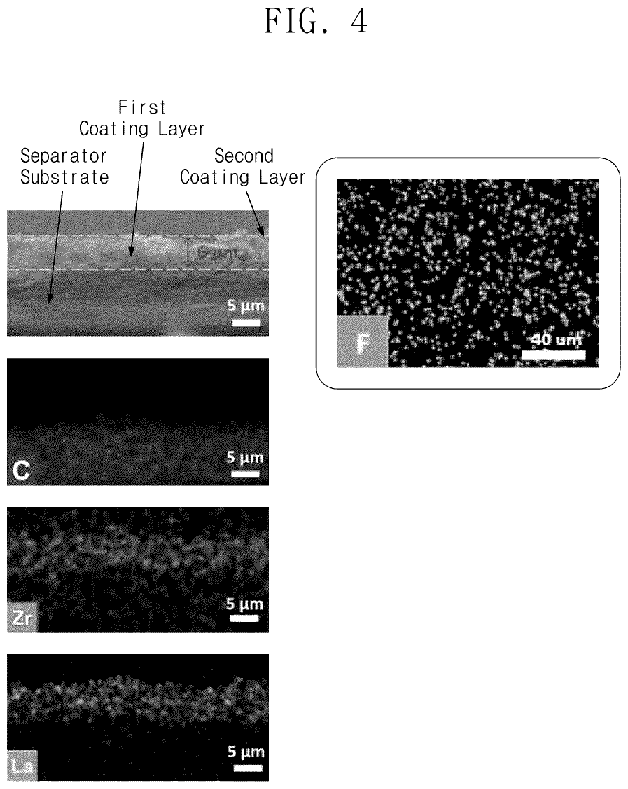

FIG. 4 shows SEM and EDS mapping images of Example 1.

Referring to FIG. 4, it may be confirmed through the SEM image that the first coating layer having a thickness of about 6 μm is formed on the separator substrate. In addition, it may be confirmed through the EDS mapping images that the first coating layer including zirconium (Zr) and lanthanum (La) is formed on the separator substrate including carbon (C). The second coating layer has a thickness of about 5 nm to about 15 nm, which is relatively smaller than the thickness of the first coating layer, and thus the second coating layer is not clearly shown on the cross-section of the SEM image, but it may be confirmed that the second coating layer is formed by confirming the presence of fluorine (F) through the EDS mapping images.

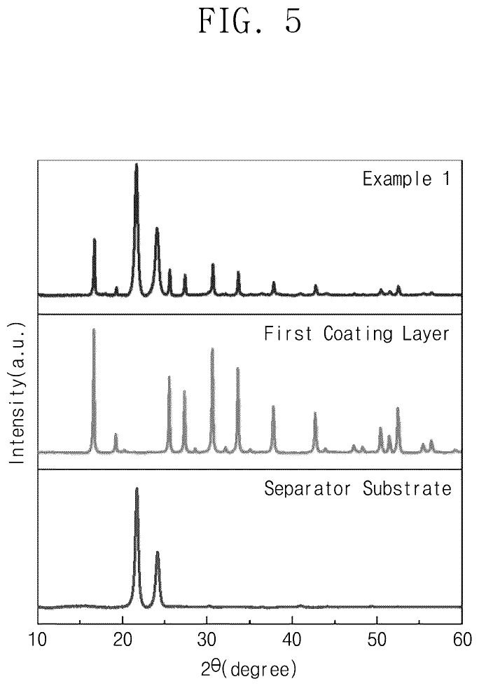

FIG. 5 shows XRD graphs of Example 1, the first coating layer, and the separator substrate.

Referring to FIG. 5, it may be confirmed that the XRD graph of Example 1 shows a mixture of the peaks of the separator substrate and the first coating layer, but the peak of the first coating layer are smaller than the peak of the separator substrate due to the first coating layer having a smaller thickness than the separator substrate.

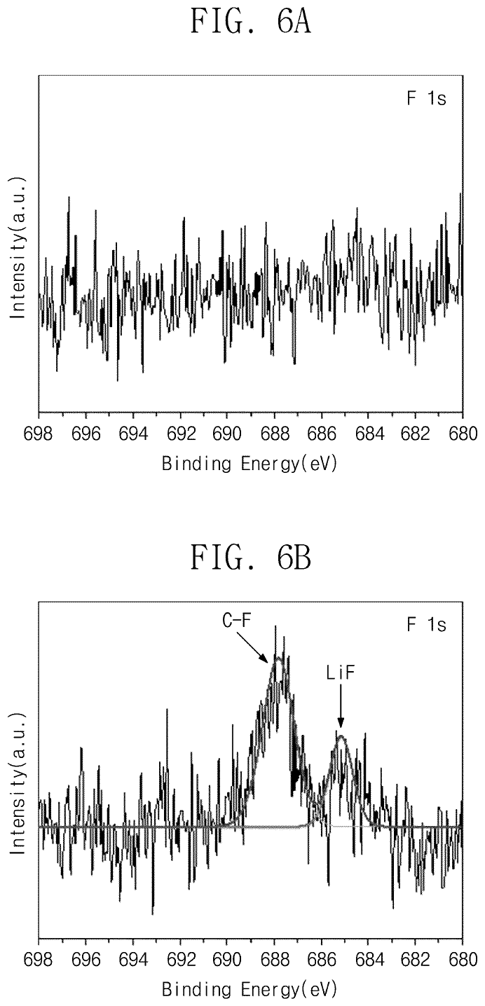

FIG. 6A is an XPS graph of F 1 s of the first coating layer. FIG. 6B is an XPS graph of F 1 s of the second coating layer on the first coating layer.

Referring to FIGS. 6A and 6B, the XPS graph of the first coating layer does not show the peak of F 1 s, whereas when the second coating layer is formed, the peak of F 1 s is shown, and thus it may be confirmed that lithium fluoride is formed.

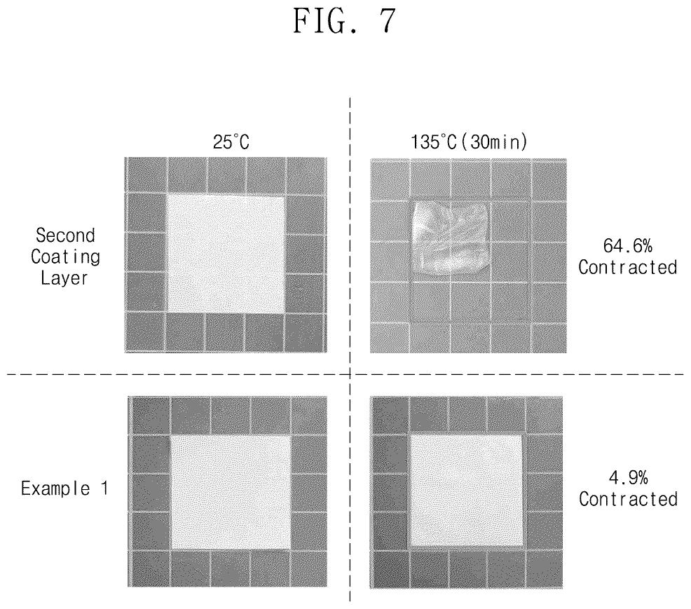

FIG. 7 shows images showing the results of the thermal shrinkage test of the separator substrate and Example 1. The heat shrinkage test was performed by putting the separator substrate and Example 1 in an oven maintained at about 135° C. and observing the change after 30 minutes.

Referring to FIG. 7, as a result of performing the shrinkage test at about 135° C., it may be confirmed that the separator substrate was contracted by about 64.6% compared to before the test, whereas Example 1 was contracted by about 4.9% compared to before the test. Accordingly, it may be confirmed that Example 1 is more stable at a higher temperature than the separator substrate.

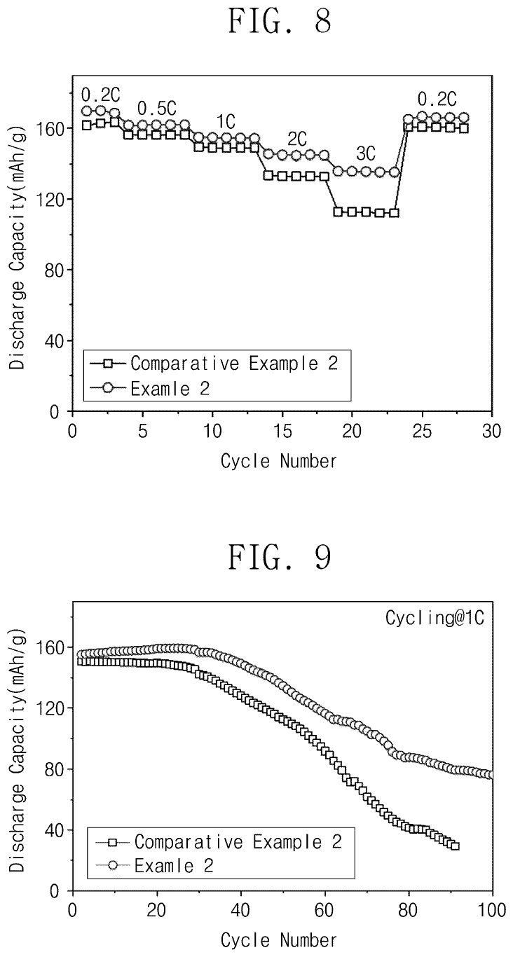

FIG. 8 shows a graph obtained by measuring discharge capacities depending on changes in current densities of Comparative Example 2 and Example 2.

Referring to FIG. 8, it may be confirmed that, as the current density increases, Example 2 exhibits a higher discharge capacity than Comparative Example 2.

FIG. 9 shows a graph obtained by measuring discharge capacities implemented between the charging and discharging cycles of Comparative Example 2 and Example 2.

Referring to FIG. 9, similar discharge capacities are shown in a small number of cycles, and the difference in discharge capacities increases as the number of cycles increases.

The separator for a lithium secondary battery according to an embodiment of the inventive concept may include the first coating layer and the second coating layer on the polymer separator. The first coating layer is for uniform dispersion and flow of lithium ions in the lithium secondary battery, and accordingly, the transport of lithium ions in the separator may be accelerated. In addition, the second coating layer may suppress a side reaction between the first coating layer and lithium on the first coating layer and the infiltration of lithium into the first coating layer, and may prevent the formation of lithium dendrites. It is possible to minimize the loss of lithium, thereby improving the charging/discharging performance and life characteristics of the lithium secondary battery.

Although the embodiments of the inventive concept have been described with reference to the accompanying drawings, those with ordinary skill in the technical field to which the inventive concept pertains will understood that the present disclosure can be carried out in other specific forms without changing the technical idea or essential features. Therefore, the above-disclosed embodiments are to be considered in all aspects as illustrative and not restrictive.

What is claimed is:

1. A separator for a lithium secondary battery comprising:
a separator substrate;
a first coating layer on the separator substrate; and
a second coating layer on the first coating layer,
wherein the first coating layer comprises a solid electrolyte, and the second coating layer comprises a lithium compound.

2. The separator for a lithium secondary battery of claim 1, wherein the first coating layer comprises at least one of an oxide-based solid electrolyte, a phosphate-based solid electrolyte, or a sulfide-based solid electrolyte, or a combination thereof.

3. The separator for a lithium secondary battery of claim 1, wherein the second coating layer comprises at least one of lithium fluoride, lithium nitride, lithium phosphate, or lithium phosphorous sulfide, or a combination thereof.

4. The separator for a lithium secondary battery of claim 1, wherein the first coating layer has a thickness of about 1 μm to about 15 μm.

5. The separator for a lithium secondary battery of claim 1, wherein the first coating layer has a porosity of about 15% to about 60%.

6. The separator for a lithium secondary battery of claim 1, wherein the second coating layer has an ion conductivity of about 10⁻⁹ S/cm to about 10⁻⁵ S/cm.

7. The separator for a lithium secondary battery of claim 1, wherein the second coating layer has an electron conductivity of about 10⁻¹⁴ S/cm to about 10⁻⁹ S/cm.

8. The separator for a lithium secondary battery of claim 1, wherein the second coating layer has a thickness of about 5 nm to about 50 nm.

9. The separator for a lithium secondary battery of claim 1, wherein the first coating layer has more uniform pore distribution than the separator substrate.

10. The separator for a lithium secondary battery of claim 1, wherein the separator substrate comprises polyolefin.

11. A lithium secondary battery comprising:
a positive electrode;
a negative electrode facing the positive electrode;
a separator between the positive electrode and the above negative electrode; and
a liquid electrolyte in contact with the positive electrode, the negative electrode, and the separator,
wherein the separator comprises:
a separator substrate;
a first coating layer on the separator substrate; and
a second coating layer on the first coating layer,
wherein the second coating layer is configured to suppress the infiltration of materials constituting the negative electrode into the first coating layer, and
the first coating layer has more uniform pore distribution than the separator substrate.

12. The lithium secondary battery of claim 11, wherein the first coating layer comprises at least one of an oxide-based solid electrolyte, a phosphate-based solid electrolyte, or a sulfide-based solid electrolyte, or a combination thereof.

13. The lithium secondary battery of claim 11, wherein the second coating layer comprises at least one of lithium fluoride, lithium nitride, lithium phosphate, or lithium phosphorous sulfide, or a combination thereof.

14. The lithium secondary battery of claim 11, wherein the first coating layer comprises a spherical solid electrolyte, a linear solid electrolyte, and a planar solid electrolyte.

15. The lithium secondary battery of claim 14, wherein the spherical solid electrolyte has a diameter of about 50 nm to about 3 μm.

16. The lithium secondary battery of claim 14, wherein the linear solid electrolyte has a diameter of about 50 nm to about 1 μm, and the length relative to the diameter is about 20 to about 1,000.

17. The lithium secondary battery of claim 14, wherein the planar solid electrolyte has an area of about 0.01 μm² to about 10 μm², and a thickness of about 50 nm to about 1 μm.

18. The lithium secondary battery of claim 11, wherein the negative electrode comprises a lithium metal.

19. A method for manufacturing a separator for a lithium secondary battery, the method comprising:
mixing a solid electrolyte, a binder, and a solvent to prepare a slurry;
applying the slurry on a separator substrate to form a first coating layer; and
forming a second coating layer including a lithium compound on the first coating layer,
wherein the first coating layer has more uniform pore distribution than the separator substrate.

20. The method of claim 19, wherein the second coating layer comprises at least one of lithium fluoride, lithium nitride, lithium phosphate, or lithium phosphorous sulfide, or a combination thereof.
